(19) United States
(12) Patent Application Publication
(10) Pub. No.: US 2025/0080925 A1
(43) Pub. Date: Mar. 6, 2025

(54) APPARATUSES, SYSTEMS, AND METHODS FOR ASSISTING INDIVIDUALS WITH EAR-WORN DEVICES TO WATCH TELEVISION

(71) Applicant: Chromatic Inc., New York, NY (US)

(72) Inventors: Davide Asnaghi, New York, NY (US); Jonathan Macoskey, Pittsburgh, PA (US); Nicholas Morris, Brooklyn, NY (US); Matthew de Jonge, Brooklyn, NY (US)

(21) Appl. No.: 18/814,724

(22) Filed: Aug. 26, 2024

Related U.S. Application Data
(60) Provisional application No. 63/579,044, filed on Aug. 28, 2023.

(51) Int. Cl. H04R 25/00; H04N 21/41; H04N 21/439

(52) U.S. Cl. CPC H04R 25/507; H04N 21/4104; H04N 21/439; H04R 25/554; H04R 2225/55

(57) ABSTRACT

A TV streamer may be configured to receive audio associated with a TV program; transmit the audio, or a processed version of it, to hearing aids over a wireless connection; and determine when a delay time has elapsed. In some embodiments, the TV streamer may be configured to then generate sound based on the audio, or a processed version of it, after the delay time has elapsed. In some embodiments, the TV streamer may be configured to then transmit the audio, or a processed version of it, to another device after the delay time has elapsed.

### BACKGROUND

### Field

The present disclosure relates to apparatuses, systems, and methods for assisting individuals with ear-worn devices such as hearing aids to watch television.

### Related Art

Certain ear-worn devices such as hearing aids are used to help those who have trouble hearing to hear better. Typically, hearing aids amplify received sound. Some hearing aids attempt to remove environmental noise from incoming sound.

### SUMMARY

According to one aspect of the technology described herein, a television (TV) streamer includes communication circuitry, control circuitry, and delay circuitry. The control circuitry is configured to control the communication circuitry to receive audio associated with a TV program; control the communication circuitry to transmit the audio, or a first processed version of it, to hearing aids over a wireless connection; use the delay circuitry to determine when a delay time has elapsed; and control the communication circuitry to transmit the audio, or a second processed version of it, to another device after the delay time has elapsed.

In some embodiments, the delay time is selected such that sound generated based on the audio, or the second processed version of it, transmitted to the other device, and sound generated by the hearing aids based on the audio, or the first processed version of it, reach ears of a wearer of the hearing aids within 10 milliseconds of each other.

In some embodiments, the TV streamer further includes processing circuitry configured to reduce noise in the audio using a neural network, and the control circuitry is configured to control the communication circuitry to transmit the noise-reduced audio to the hearing aids. In some embodiments, the processing circuitry is further configured to buffer a window of the audio equal to or more than 50 milliseconds in length prior to using the neural network to reduce noise in the audio.

In some embodiments, the control circuitry is configured to control the communication circuitry to receive video associated with the TV program, and use the delay circuitry to delay the video prior to controlling the communication circuitry to transmit the video to a TV.

In some embodiments, the other device includes a soundbar or a TV.

In some embodiments, the TV streamer is integrated into a TV.

In some embodiments, the TV streamer is further configured to measure a streaming delay in streaming data to the hearing aids, and the delay time is based on the streaming delay.

In some embodiments, the TV streamer further includes processing circuitry configured to adjust a sound profile of the audio based on a type of the audio.

According to one aspect of the technology described herein, a TV streamer includes communication circuitry, control circuitry, delay circuitry, and one or more speakers. The control circuitry is configured to control the communication circuitry to receive audio associated with a TV program; control the communication circuitry to transmit the audio, or a first processed version of it, to hearing aids over a wireless connection; use the delay circuitry to determine when a delay time has elapsed; and control the one or more speakers to generate sound based on the audio, or a second processed version of it, after the delay time has elapsed.

In some embodiments, the delay time is selected such that the sound generated by the one or more speakers based on the audio, or the second processed version of it, and sound generated by the hearing aids based on the audio, or the first processed version of it, reach ears of a wearer of the hearing aids within 10 milliseconds of each other.

In some embodiments, the TV streamer further includes processing circuitry configured to reduce noise in the audio using a neural network, and the control circuitry is configured to control the communication circuitry to transmit the noise-reduced audio to the hearing aids.

In some embodiments, the processing circuitry is further configured to buffer a window of the audio equal to or more than 50 milliseconds in length prior to using the neural network to reduce noise in the audio.

In some embodiments, the communication circuitry is configured to receive video associated with the TV program, and the control circuitry is configured to delay the video prior to controlling the communication circuitry to transmit the video to a TV.

In some embodiments, the TV streamer is coupled to a TV or to an audiovisual (AV) source by a single cable.

In some embodiments, the TV streamer includes soundbar functionality in a single device.

In some embodiments, the TV streamer is integrated into a TV.

In some embodiments, the TV streamer is further configured to measure a streaming delay in streaming data to the hearing aids, and the delay time is based on the streaming delay.

In some embodiments, the TV streamer further includes processing circuitry configured to adjust a sound profile of the audio based on a type of the audio.

In some embodiments, the TV streamer further includes processing circuitry configured to boost low frequencies in the audio.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in all the figures in which they appear.

FIG. 1 is a block diagram illustrating an audiovisual (AV) system, in accordance with certain embodiments described herein;

FIG. 2 is a block diagram illustrating an AV system, in accordance with certain embodiments described herein;

FIG. 3 is a block diagram illustrating an AV system, in accordance with certain embodiments described herein;

FIG. 4 is a block diagram illustrating an AV system, in accordance with certain embodiments described herein;

FIG. 5 is a block diagram illustrating an AV system, in accordance with certain embodiments described herein;

FIG. 6 is a block diagram illustrating an AV system, in accordance with certain embodiments described herein;

FIG. 7 is a block diagram illustrating an AV system, in accordance with certain embodiments described herein;

FIG. 8 is a block diagram illustrating an AV system, in accordance with certain embodiments described herein;

FIG. 9 is a block diagram illustrating an AV system, in accordance with certain embodiments described herein;

FIG. 10 is a block diagram illustrating an AV system, in accordance with certain embodiments described herein;

FIG. 11 is a block diagram illustrating an AV system, in accordance with certain embodiments described herein;

FIG. 12 is a block diagram illustrating an AV system, in accordance with certain embodiments described herein;

FIG. 13 illustrates a block diagram of a TV streamer, in accordance with certain embodiments described herein;

FIG. 14 illustrates a block diagram of a TV streamer, in accordance with certain embodiments described herein;

FIG. 15 illustrates a process for operating an AV system, in accordance with certain embodiments described herein;

FIG. 16 illustrates a process for operating an AV system, in accordance with certain embodiments described herein;

FIG. 17 illustrates a process for operating an AV system, in accordance with certain embodiments described herein; and

FIG. 18 illustrates a process for operating an AV system, in accordance with certain embodiments described herein.

### DETAILED DESCRIPTION

Watching television (TV) is an important but difficult scenario for individuals wearing ear-worn devices such as hearing aids. Individuals wearing hearing aids may have different preferences for the sound coming from a TV than individuals not wearing aids. These preferences may conflict when individuals wearing hearing aids watch TV together with individuals not wearing hearing aids. TV streamers, which stream audio from a TV directly to hearing aids over a wireless connection, have been developed. The inventors have recognized that for many hearing aid wearers, the combination of a soundbar and a hearing aid may assist in improving the listening experience. Hearing aids (e.g., receiver-in-canal type) may have physical limitations on how well they amplify certain portions of the frequency spectrum (e.g., <200 Hz). A soundbar may be better able to output these portions of the frequency spectrum, thereby providing a more complete and balanced frequency spectrum to the hearing aid wearer than if they solely relied on the hearing aid speaker. Another benefit is that it allows for multiple individuals watching TV to listen at different volumes. If one individual does not have hearing loss, they can listen to the sound from the soundbar only at a normal volume, while simultaneously the hearing aid wearer may receive a boosted volume from the hearing aid.

However, the inventors have recognized that achieving an optimal combination of the sound from the soundbar and the hearing aid is not a trivial task. For example, one problem involves differences in timing between the two audio signals. When audio is streamed to the hearing aid, the streaming protocol may introduce some latency to the signal. If the hearing aid signal is played out at a meaningful delay to the signal from the soundbar (e.g., greater than 10 milliseconds), the two signals may interfere with one another, introducing spectral artifacts (e.g. a comb filter) into the sound heard by the hearing aid wearer. The inventors have developed technology whereby a TV streamer delays the sound coming from the soundbar so that its arrival at the ears of the hearing aid wearer coincides with, or approximately coincides with, when sound from the hearing aids arrive at the cars of the hearing aid wearer.

The inventors have also recognized that for hearing aid wearers, the TV audio signal may be difficult to understand because the TV audio signal may have significant noise competing with the speech in the TV audio signal. This may lead to a frustrating experience for people with hearing loss who have to strain to understand the speech. Because the core issue may be the signal-to-noise ratio (SNR), raising the volume through a hearing aid may not help, as this may not change the SNR for the wearer.

The inventors have recognized that this problem may be addressed by applying additional processing to the audio signal in the TV streamer to enhance the signal-to-noise ratio of the signal played out to the wearer. One method that may be used to enhance the signal to noise ratio is applying processing of a neural network to the audio signal. This neural network may be trained to separate speech from background noise. The processor may further recombine the separated speech and noise signals at a preferable signal to noise ratio. Further description of such neural networks may be found in U.S. Pat. No. 11,812,225B2, entitled “Method, Apparatus, and System for Neural Network Hearing Aid,” issued Nov. 7, 2023, which is herein incorporated by reference in its entirety.

The performance of the neural network processing may depend on the length of the input audio data that the neural network may receive before predicting a mask for a given sample of audio. In this regard, the inventors have further recognized that this processing may benefit a hearing aid wearer, but this risks introducing further latency to the path played by the hearing aid relative to the TV streamer. By introducing a means of delaying the audio to the soundbar, this processing may be applied to the audio.

Furthermore, if too much latency is introduced, then the delay of the audio signal relative to the video may impede the listening experience. Therefore, in some embodiments, the TV streamer may additionally delay the video feed so as to better align the audio signal and the video signal. In some embodiments, the ability to apply the delay to the various signals (including the video signal) furthermore allows the TV streamer to apply additional AI-processing to the audio signal while maintaining alignment of the signal at the car of the hearing aid wearer.

The inventors have further recognized that conventional TV streamers may be difficult to set up. For example, multiple cables may need to be connected to conventional TV streamers. The inventors have developed technology that creates a simple integration between an existing TV setup and a hearing aid. For example, in some embodiments, only a single cable needs to be coupled to a TV streamer described herein.

The aspects and embodiments described above, as well as additional aspects and embodiments, are described further below. These aspects and/or embodiments may be used individually, all together, or in any combination of two or more, as the disclosure is not limited in this respect.

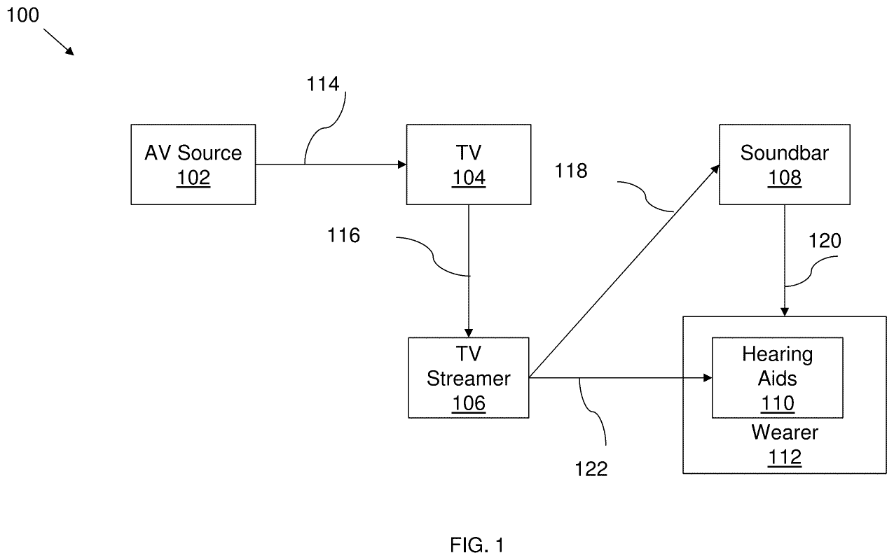

FIG. 1 is a block diagram illustrating an audiovisual (AV) system 100, in accordance with certain embodiments described herein. The AV system 100 includes an AV source 102, a TV 104, a TV streamer 106, a soundbar 108, and a wearer 112 wearing hearing aids 110. The AV source 102 is coupled to the TV 104 with a cable 114. The TV 104 is coupled to the TV streamer 106 with a cable 116. The TV streamer 106 is coupled to the soundbar 108 with a cable 118. The TV streamer 106 is coupled to the hearing aids 110 with a wireless connection 122. The soundbar 108 is configured to output sound through air to the ears of the wearer 112. A path of sound through air to the ears of the wearer 112 will be referred to as the direct path 120. Any of the cables described herein may be, for example, HDMI (e.g., HDMI ARC), optical (e.g., TOSLINK), MIDI, analog, RCA, TS/TRS, coaxial (e.g., RCA), or SPDIF/RCA cables. Any of the wireless connections described herein may be, for example, Bluetooth connections.

The AV source 102 may be configured to output audio and video data (e.g., from the internet, from a satellite dish, from a storage medium such as a disc, etc.) to the TV 104 over the cable 114. For example, the AV source 102 may be a streaming device, a cable box, a disc player, etc. The audio and video data may be associated with a TV program (where, as referred to herein, a TV program may include anything shown on a TV). The TV 104 may be configured to output the video on its display screen, and transmit the audio to the TV streamer 106 over the cable 116.

The TV streamer 106 may be configured to transmit the audio, or a processed version of it, to the hearing aids 110 over the wireless connection 122. The hearing aids 110 may be configured to output, into the ears of the wearer 112, sound generated based on the audio transmitted from the TV streamer 106. The TV streamer 106 may be further configured to transmit the audio, or a processed version of it, to the soundbar 108. As referred to herein, a soundbar may be any device separate from a TV configured to generate sounds. The soundbar 108 may be configured to convert the audio received from the TV streamer 106 into sound in air so it may be received by the ears of the wearer 112 over the direct path 120. When the TV streamer 106 is configured to transmit a processed version of the audio to the hearing aids 110 and a processed version of the audio to the soundbar 108, in some embodiments the two processed versions may be different, while in some embodiments the two processed versions may be the same.

The TV streamer 106 may be configured to delay when it transmits the audio to the soundbar 108 over the cable 118 relative to when it transits the audio to the hearing aids 110 over the wireless connection 122. For example, when the TV streamer 106 receives audio from the TV 104, the TV streamer 106 may then transmit that audio, or a processed version of it, to the hearing aids 110 over the wireless connection 122 at a time t0. At a time t0+d, where d is a delay, the TV streamer 106 may then transmit that same audio, or a processed version of it, to the soundbar 108. The TV streamer 106 may be configured to implement the delay d such that sound over the direct path 120 and sound from the hearing aids 110 arrive at the wearer's ears at the same time, or approximately the same time (e.g., within 10 milliseconds of each other).

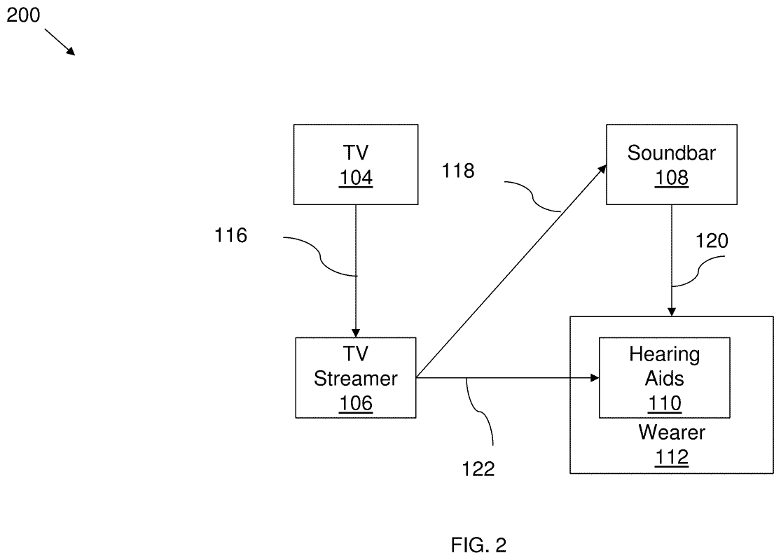

FIG. 2 is a block diagram illustrating an audiovisual (AV) system 200, in accordance with certain embodiments described herein. The AV system 200 is the same as the AV system 100, except that the AV source 102 and the cable 114 are absent. In the AV system 200, the TV 104 may itself contain an AV source. For example, the TV 104 may be a smart TV configured to receive TV programs over the internet.

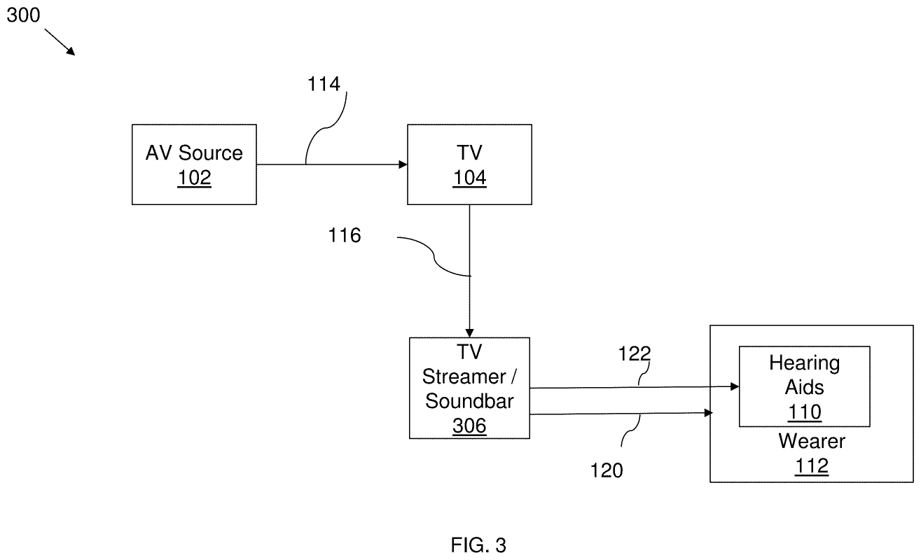

FIG. 3 is a block diagram illustrating an audiovisual (AV) system 300, in accordance with certain embodiments described herein. The AV system 300 includes the AV source 102, the TV 104, a TV streamer and soundbar 306, and the wearer 112 wearing the hearing aids 110. The TV streamer and soundbar 306 is one device that has the functionality of both a TV streamer and a soundbar. In other words, it has functionality to both stream audio to the hearing aids 110 and to output sound through air. The AV source 102 is coupled to the TV 104 with the cable 114. The TV 104 is coupled to the TV streamer and soundbar 306 with the cable 116. The TV streamer and soundbar 306 is coupled to the hearing aids 110 with the wireless connection 122. The TV streamer and soundbar 306 is also configured to output sound through air to the ears of the wearer 112 over the direct path 120. It should be appreciated that in the AV system 300, only a single cable 116 needs to be coupled to the TV streamer and soundbar 306.

The AV source 102 may be configured to output audio and video data (e.g., from the internet, from a satellite dish, from a storage medium such as a disc, etc.) to the TV 104 over the cable 114. The audio and video data may be associated with a TV program (where, as referred to herein, a TV program may include anything shown on a TV). The TV 104 may be configured to output the video on its display screen, and transmit the audio to the TV streamer and soundbar 306 over the cable 116. The TV streamer and soundbar 306 may be configured to transmit the audio, or a processed version of it, to the hearing aids 110 over the wireless connection 122. The hearing aids 110 may be configured to output, into the ears of the wearer 112, sound generated based on the audio transmitted from the TV streamer and soundbar 306. The TV streamer and soundbar 306 may be further configured to convert that audio, or a processed version of it, into sound which may be transmitted through air to the ears of the wearer 112 over the direct path 120. When the TV streamer and soundbar 306 is configured to transmit a processed version of the audio to the hearing aids 110 and to convert a processed version of the audio into sound, in some embodiments the two processed versions may be different, while in some embodiments the two processed versions may be the same.

The TV streamer and soundbar 306 may be configured to delay when it transmits sound in air to the wearer 112 over the direct path 120 relative to when it transits the audio to the hearing aids 110 over the wireless connection 122. For example, when the TV streamer and soundbar 306 receives audio from the TV 104, the TV streamer and soundbar 306 may then transmit that audio, or a processed version of it, to the hearing aids 110 over the wireless connection 122 at a time t0. At a time t0+d, where d is a delay, the TV streamer and soundbar 306 may then convert that same audio, or a processed version of it, into sound which may be transmitted in air to the ears of the wearer 112 over the direct path 120. The TV streamer and soundbar 306 may be configured to implement the delay d such that sound over the direct path 120 and sound from the hearing aids 110 arrive at the wearer's ears at the same time, or approximately the same time (e.g., within 10 milliseconds of each other).

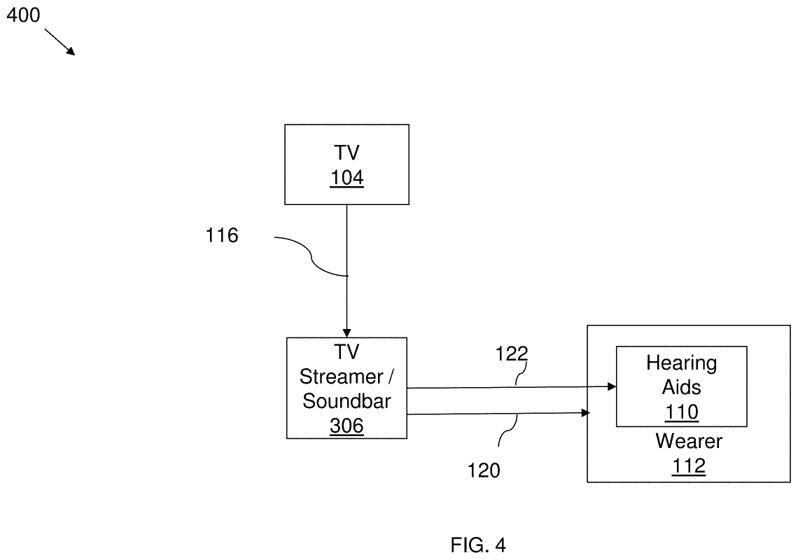

FIG. 4 is a block diagram illustrating an audiovisual (AV) system 400, in accordance with certain embodiments described herein. The AV system 400 is the same as the AV system 300, except that the AV source 102 and the cable 114 are absent. In the AV system 400, the TV 104 may itself contain an AV source. For example, the TV 104 may be a smart TV configured to receive TV programs over the internet. It should be appreciated that in the AV system 400, only a single cable 116 needs to be coupled to the TV streamer and soundbar 306.

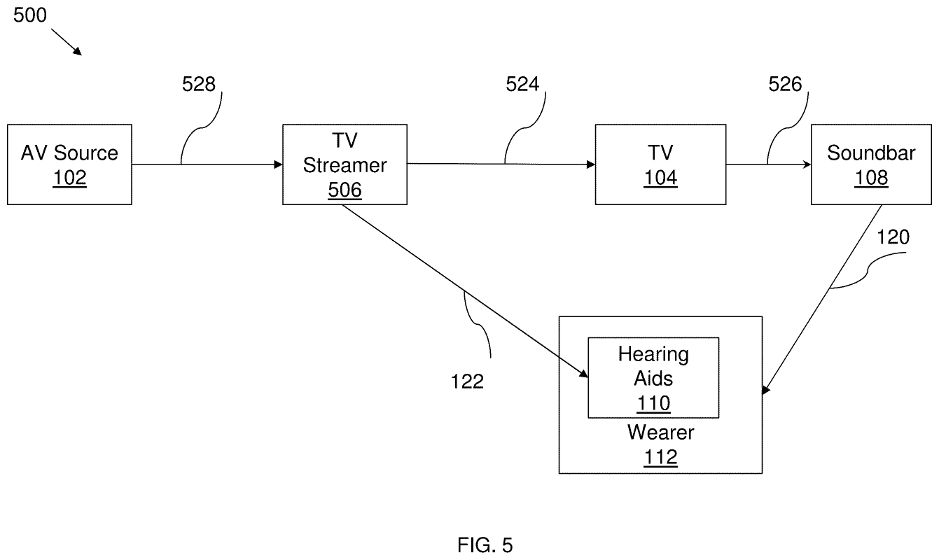

FIG. 5 is a block diagram illustrating an audiovisual (AV) system 500, in accordance with certain embodiments described herein. The AV system 500 includes the AV source 102, the TV 104, a TV streamer 506, the soundbar 108, and the wearer 112 wearing the hearing aids 110. The AV source 102 is coupled to the TV streamer 506 with the cable 528. The TV streamer 506 is coupled to the TV 104 with a cable 524. The TV streamer 506 is coupled to the hearing aids 110 with the wireless connection 122. The TV 104 is coupled to the soundbar 108 with a cable 526. The soundbar 108 is configured to output sound through air to the ears of the wearer 112.

The AV source 102 may be configured to output audio and video data (e.g., from the internet, from a satellite dish, from a storage medium such as a disc, etc.) to the TV streamer 506 over the cable 528. The audio and video data may be associated with a TV program (where, as referred to herein, a TV program may include anything shown on a TV). The TV streamer 506 may be configured to transmit the audio, or a processed version of it, to the hearing aids 110 over the wireless connection 122. The hearing aids 110 may be configured to output, into the ears of the wearer 112, sound generated based on the audio transmitted from the TV streamer 506. The TV streamer 506 may be further configured to transmit the audio, or a processed version of it, and video to the TV 104 over the cable 524. The TV 104 may be configured to output the video on its display screen, and transmit the audio to the soundbar 108 over the cable 526. The soundbar 108 may be configured to convert the audio received from the TV 104 into sound in air so it may be received by the ears of the wearer 112 over the direct path 120. When the TV streamer 506 is configured to transmit a processed version of the audio to the hearing aids 110 and a processed version of the audio to the TV 104, in some embodiments the two processed versions may be different, while in some embodiments the two processed versions may be the same.

The TV streamer 506 may be configured to delay when it transmits the audio to the TV 104 over the cable 524 relative to when it transmits the audio to the hearing aids 110 over the wireless connection 122. For example, when the TV streamer 506 receives audio from the AV source 102, the TV streamer 506 may then transmit that audio, or a processed version of it, to the hearing aids 110 over the wireless connection 122 at a time t0. At a time t0+d, where d is a delay, the TV streamer 506 may then transmit that same audio, or a processed version of it, to the TV 104. The TV streamer 506 may be configured to implement the delay d such that sound over the direct path 120 and sound from the hearing aids 110 arrive at the wearer's ears at the same time, or approximately the same time (e.g., within 10 milliseconds of each other).

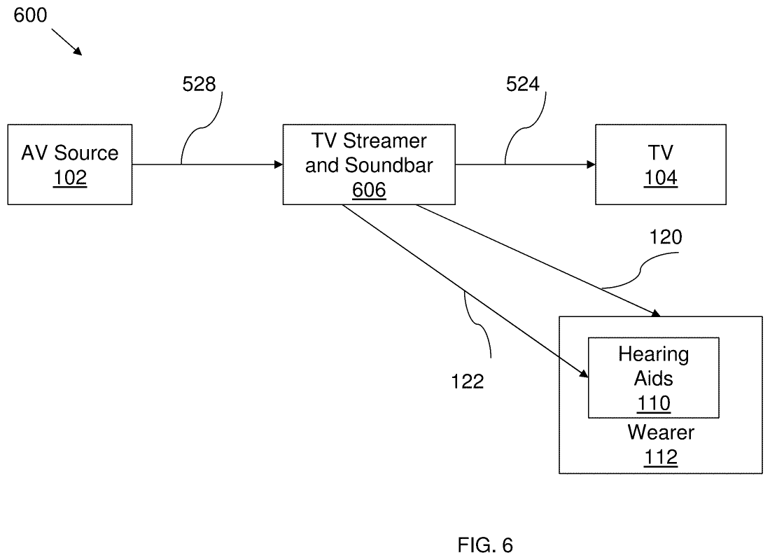

FIG. 6 is a block diagram illustrating an audiovisual (AV) system 600, in accordance with certain embodiments described herein. The AV system 600 includes the AV source 102, the TV 104, a TV streamer and soundbar 606, and the wearer 112 wearing the hearing aids 110. The TV streamer and soundbar 606 is one device that has the functionality of both a TV streamer and a soundbar. In other words, it has functionality to both stream audio to the hearing aids 110 and to output sound through air. The AV source 102 is coupled to the TV streamer and soundbar 606 with the cable 528. The TV streamer and soundbar 606 is coupled to the TV 104 with the cable 524. The TV streamer and soundbar 606 is coupled to the hearing aids 110 with the wireless connection 122. The TV streamer and soundbar 606 is also configured to output sound through air to the ears of the wearer 112 over the direct path 120.

The AV source 102 may be configured to output audio and video data (e.g., from the internet, from a satellite dish, from a storage medium such as a disc, etc.) to the TV streamer and soundbar 606 over the cable 528. The audio and video data may be associated with a TV program (where, as referred to herein, a TV program may include anything shown on a TV). The TV streamer and soundbar 606 may be configured to transmit the audio, or a processed version of it, to the hearing aids 110 over the wireless connection 122. The hearing aids 110 may be configured to output, into the ears of the wearer 112, sound generated based on the audio transmitted from the TV streamer and soundbar 606. The TV streamer and soundbar 606 may be further configured to convert that audio, or a processed version of it, into sound which may be transmitted through air to the ears of the wearer 112 over the direct path 120. The TV streamer and soundbar 606 may be configured to transmit the video to the TV 104 over the cable 524, and the TV 104 may be configured to output the video on its display screen. When the TV streamer and soundbar 606 is configured to transmit a processed version of the audio to the hearing aids 110 and to convert a processed version of the audio into sound, in some embodiments the two processed versions may be different, while in some embodiments the two processed versions may be the same.

The TV streamer and soundbar 606 may be configured to delay when it transmits sound in air to the wearer 112 over the direct path 120 relative to when it transits the audio to the hearing aids 110 over the wireless connection 122. For example, when the TV streamer and soundbar 606 receives audio from the AV source 102, the TV streamer and soundbar 606 may then transmit that audio, or a processed version of it, to the hearing aids 110 over the wireless connection 122 at a time t0. At a time t0+d, where d is a delay, the TV streamer and soundbar 606 may then convert that same audio, or a processed version of it, into sound which may be transmitted in air to the ears of the wearer 112 over the direct path 120. The TV streamer and soundbar 606 may be configured to implement the delay d such that sound over the direct path 120 and sound from the hearing aids 110 arrive at the wearer's ears at the same time, or approximately the same time (e.g., within 10 milliseconds of each other).

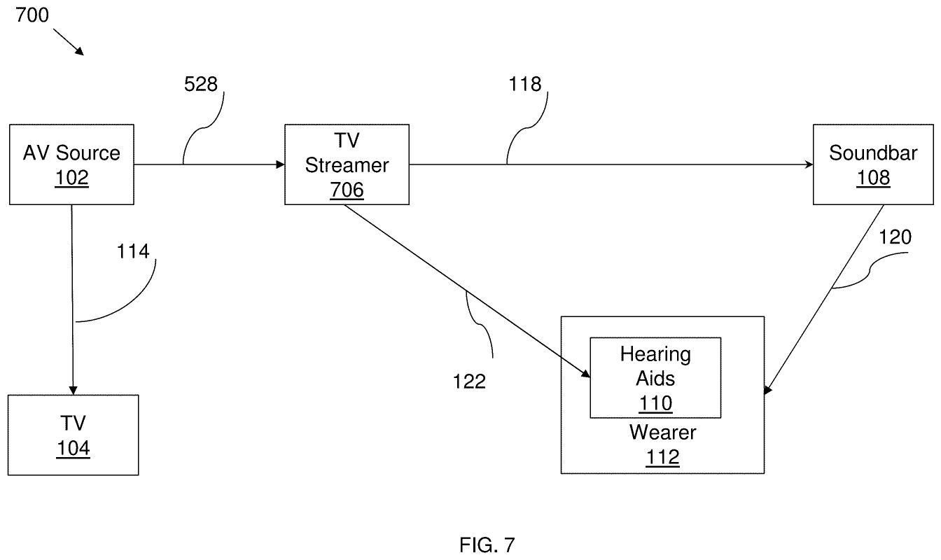

FIG. 7 is a block diagram illustrating an audiovisual (AV) system 700, in accordance with certain embodiments described herein. The AV system 700 includes the AV source 102, the TV 104, a TV streamer 706, the soundbar 108, and the wearer 112 wearing the hearing aids 110. The AV source 102 is coupled to the TV streamer 706 with the cable 528. The AV source 102 is coupled to the TV 104 with the cable 114. The TV streamer 706 is coupled to the hearing aids 110 with the wireless connection 122. The TV streamer 706 is coupled to the soundbar 108 with the cable 118. The soundbar 108 is configured to output sound through air to the ears of the wearer 112.

The AV source 102 may be configured to output video data (e.g., from the internet, from a satellite dish, from a storage medium such as a disc, etc.) to the TV 104 over the cable 114, and output audio data (e.g., from the internet, from a satellite dish, from a storage medium such as a disc, etc.) to the TV streamer 706 over the cable 528. The audio and video data may be associated with a TV program (where, as referred to herein, a TV program may include anything shown on a TV). The TV 104 may be configured to output the video on its display screen. The TV streamer 706 may be configured to transmit the audio, or a processed version of it, to the hearing aids 110 over the wireless connection 122. The hearing aids 110 may be configured to output, into the ears of the wearer 112, sound generated based on the audio transmitted from the TV streamer 706. The TV streamer 706 may be further configured to transmit the audio, or a processed version of it, to the soundbar 108 over the cable 118. The soundbar 108 may be configured to convert the audio received from the TV streamer 706 into sound in air so it may be received by the ears of the wearer 112 over the direct path 120. When the TV streamer 706 is configured to transmit a processed version of the audio to the hearing aids 110 and a processed version of the audio to the soundbar 108, in some embodiments the two processed versions may be different, while in some embodiments the two processed versions may be the same.

The TV streamer 706 may be configured to delay when it transmits the audio to the soundbar 108 over the cable 118 relative to when it transits the audio to the hearing aids 110 over the wireless connection 122. For example, when the TV streamer 706 receives audio from the AV source 102, the TV streamer 706 may then transmit that audio, or a processed version of it, to the hearing aids 110 over the wireless connection 122 at a time t0. At a time t0+d, where d is a delay, the TV streamer 706 may then transmit that same audio, or a processed version of it, to the soundbar 108. The TV streamer 706 may be configured to implement the delay d such that sound over the direct path 120 and sound from the hearing aids 110 arrive at the wearer's ears at the same time, or approximately the same time (e.g., within 10 milliseconds of each other).

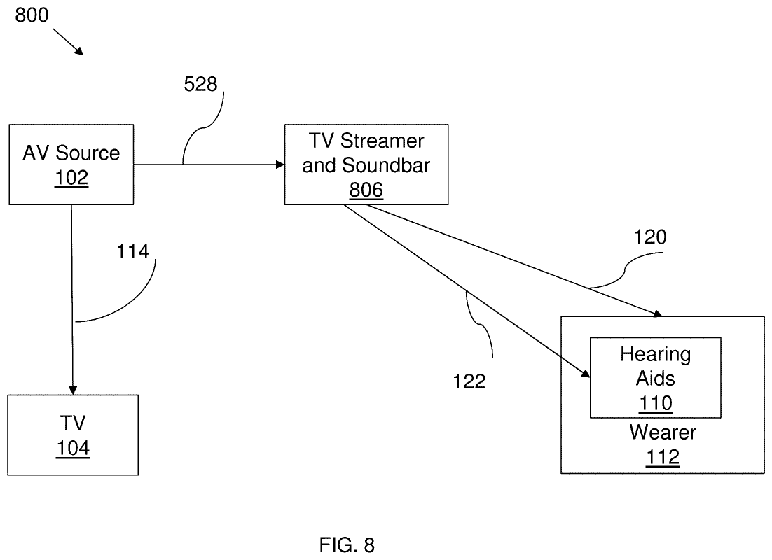

FIG. 8 is a block diagram illustrating an audiovisual (AV) system 800, in accordance with certain embodiments described herein. The AV system 800 includes the AV source 102, the TV 104, a TV streamer and soundbar 806, and the wearer 112 wearing the hearing aids 110. The TV streamer and soundbar 806 is one device that has the functionality of both a TV streamer and a soundbar. In other words, it has functionality to both stream audio to the hearing aids 110 and to output sound through air. The AV source 102 is coupled to the TV streamer and soundbar 606 with the cable 528. The AV source 102 is coupled to the TV 104 with the cable 114. The TV streamer and soundbar 806 is coupled to the hearing aids 110 with the wireless connection 122. The TV streamer and soundbar 806 is also configured to output sound through air to the ears of the wearer 112 over the direct path 120. It should be appreciated that in the AV system 800, only a single cable 528 needs to be coupled to the TV streamer and soundbar 306.

The AV source 102 may be configured to output video data (e.g., from the internet, from a satellite dish, from a storage medium such as a disc, etc.) to the TV 104 over the cable 114, and output audio data (e.g., from the internet, from a satellite dish, from a storage medium such as a disc, etc.) to the TV streamer and soundbar 806 over the cable 528. The audio and video data may be associated with a TV program (where, as referred to herein, a TV program may include anything shown on a TV). The TV 104 may be configured to output the video on its display screen. The TV streamer and soundbar 806 may be configured to transmit the audio, or a processed version of it, to the hearing aids 110 over the wireless connection 122. The hearing aids 110 may be configured to output, into the ears of the wearer 112, sound generated based on the audio transmitted from the TV streamer and soundbar 806. The TV streamer and soundbar 806 may be further configured to convert that audio, or a processed version of it, into sound which may be transmitted in air to the ears of the wearer 112 over the direct path 120. When the TV streamer and soundbar 806 is configured to transmit a processed version of the audio to the hearing aids 110 and to convert a processed version of the audio into sound, in some embodiments the two processed versions may be different, while in some embodiments the two processed versions may be the same.

The TV streamer and soundbar 806 may be configured to delay when it transmits sound in air to the wearer 112 over the direct path 120 relative to when it transits the audio to the hearing aids 110 over the wireless connection 122. For example, when the TV streamer and soundbar 806 receives audio from the AV source 102, the TV streamer and soundbar 806 may then transmit that audio, or a processed version of it, to the hearing aids 110 over the wireless connection 122 at a time t0. At a time t0+d, where d is a delay, the TV streamer and soundbar 806 may then convert that same audio, or a processed version of it, into sound that may be transmitted in air to the ears of the wearer 112 over the direct path 120. The TV streamer and soundbar 806 may be configured to implement the delay d such that sound over the direct path 120 and sound from the hearing aids 110 arrive at the wearer's ears at the same time, or approximately the same time (e.g., within 10 milliseconds of each other).

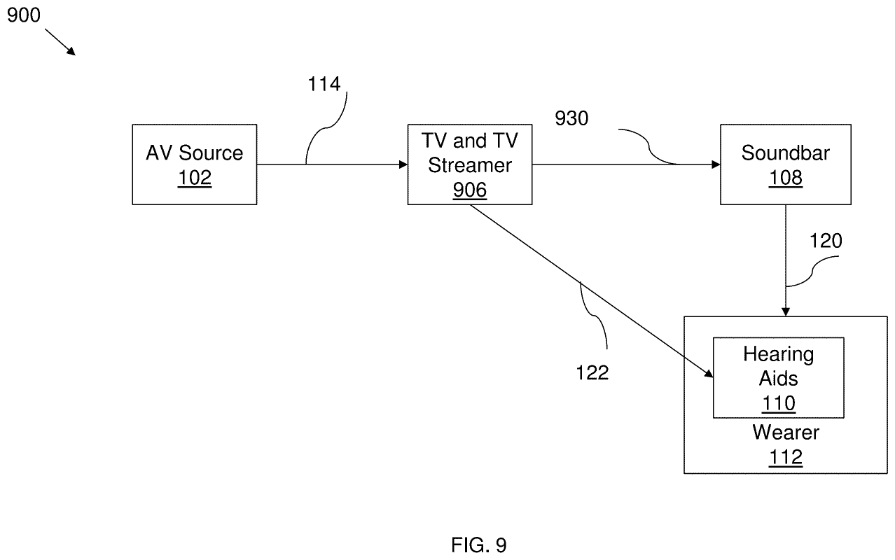

FIG. 9 is a block diagram illustrating an audiovisual (AV) system 900, in accordance with certain embodiments described herein. The AV system 900 is the same as the AV system 100, except that the AV system 900 includes a TV and TV streamer 906 incorporating both TV and TV streamer in one device. In other words, the TV streamer is integrated into the TV.

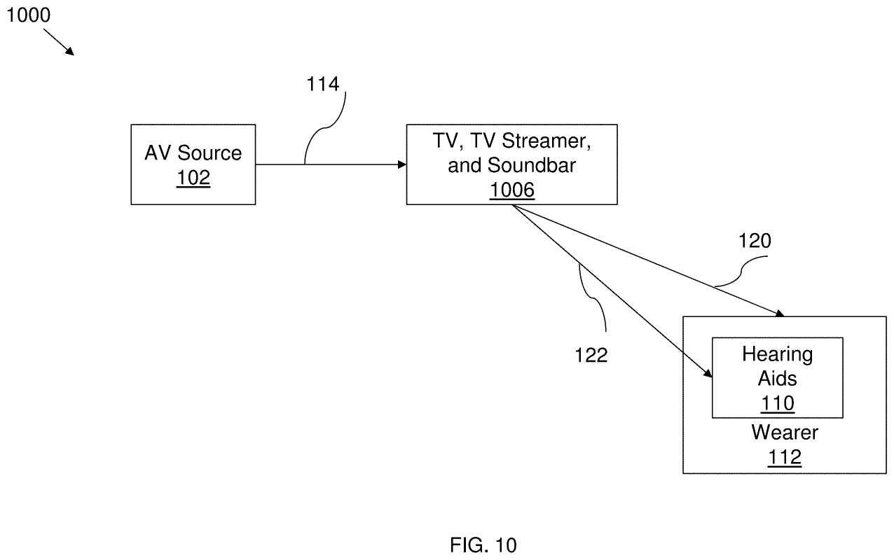

FIG. 10 is a block diagram illustrating an audiovisual (AV) system 1000, in accordance with certain embodiments described herein. The AV system 1000 is the same as the AV system 900, except that the AV system 1000 includes a TV, TV streamer, and soundbar 1006 incorporating TV, TV streamer, and soundbar functionality in one device.

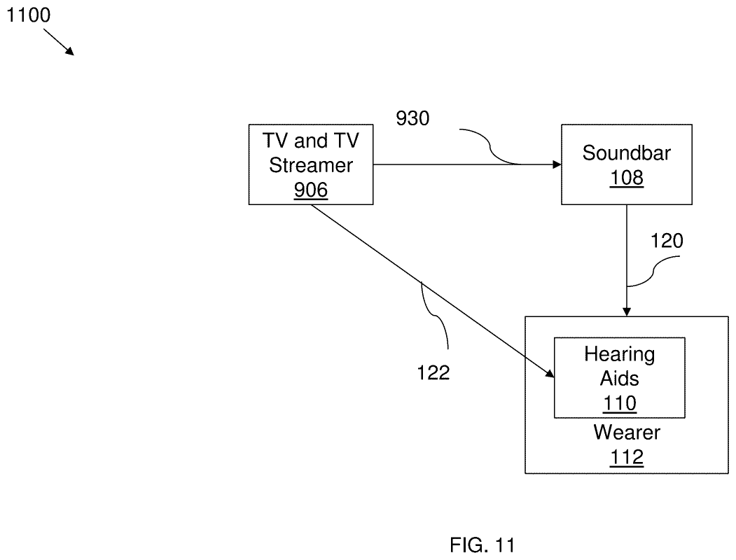

FIG. 11 is a block diagram illustrating an audiovisual (AV) system 1100, in accordance with certain embodiments described herein. The AV system 1100 is the same as the AV system 900, except that the AV source 102 and the cable 114 are absent. In the AV system 1100, the TV and TV streamer 906 may itself contain an AV source. For example, the TV and TV streamer 906 may be a smart TV configured to receive TV programs over the internet.

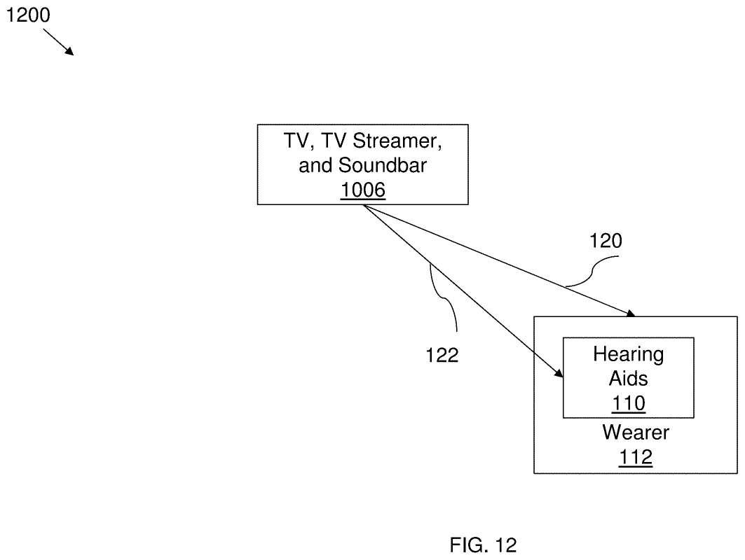

FIG. 12 is a block diagram illustrating an audiovisual (AV) system 1200, in accordance with certain embodiments described herein. The AV system 1200 is the same as the AV system 1000, except that the AV source 102 and the cable 114 are absent. In the AV system 1200, the TV, TV streamer, and soundbar 1006 may itself contain an AV source. For example, the TV, TV streamer, and soundbar 1006 may be a smart TV configured to receive TV programs over the internet.

Thus, in any of the embodiments described above, a TV streamer (where “TV streamer” as referred to herein may refer to any device with TV streaming functionality, including devices with both TV streamer and soundbar functionality, such as the TV streamers 106, 506, 706, and 906, and the TV streamer and soundbars 306, 606, 806, and 1006) may be configured to implement a delay d such that sound over the direct path 120 and sound from the hearing aids 110 arrive at the wearer's ears at the same time, or approximately the same time (e.g., within 10 milliseconds of each other). The delay may be implemented by the TV streamer in audio sent to another device (e.g., the soundbar 108 in the AV systems 100, 200, 700, 900, 1100 or the TV 104 in the AV system 500) or in sound outputted into air over the direct path when the TV streamer has soundbar functionality (e.g., in the AV systems 300, 400, 600, 800, 1000, 1200). In some embodiments, the delay implemented by the TV streamer may be a predetermined value. In some embodiments, the delay implemented by the TV streamer may be selectable by the wearer 112. For example, the wearer 112 may test different delays until the experience is satisfactory. In some embodiments, the TV streamer may automatically determine the delay. In other words, the TV streamer may be configured to dynamically match the delay for sound over the direct path 120 to the delay for sound from the hearing aids 110. The latter delay, namely the delay in streaming data to the hearing aids 110, may be referred to as the “streaming delay.” In some embodiments, the TV streamer may be configured to measure the streaming delay. In some embodiments, the TV streamer may be configured to measure the streaming delay with a roundtrip wireless packet. For example, the TV streamer may be configured to transmit a wireless packet to the hearing aids 110 over the wireless connection 122 and receive the wireless packet (or some other packet) back from the hearing aids 110 in response to the transmitted packet over the wireless connection. The TV streamer may be configured to measure the time from when the wireless packet is transmitted to when a wireless packet is received back in response (the “round trip delay”). The TV streamer may be configured to estimate the streaming delay based on halving the round trip delay. In some embodiments, the TV streamer may take half the round trip delay as the streaming delay. In some embodiments, the TV streamer may take half the round trip and add a predetermined hearing aid latency to obtain the streaming delay. The hearing aid latency may be the latency between when the hearing aids 110 receive audio over the wireless connection 122 and when the hearing aids 110 output sound based on the audio into the ears of the wearer 112. In some embodiments, the delay d may be based on the streaming delay. In some embodiments, the TV streamer may make the delay d be the same as the streaming delay. In some embodiments, the TV streamer may obtain the delay d by subtracting from the streaming delay a predetermined latency from when the TV streamer outputs audio or sound destined for the direct path 120 to when sound reaches the ears of the wearer 112 over the direct path. For example, there may be a latency associated with devices between the TV streamer and the direct path 120.

In some embodiments, the delay d may be tens of milliseconds in length. In some embodiments, the delay d may be 10-100 milliseconds in length. (As referred to herein, a delay that is X-Y milliseconds in length may be equal to X milliseconds in length, equal to Y milliseconds in length, or between X and Y milliseconds in length.) In some embodiments, the delay d may be 20-100 milliseconds in length. In some embodiments, the delay d may be 30-100 milliseconds in length. In some embodiments, the delay d may be 40-100 milliseconds in length. In some embodiments, the delay d may be 50-100 milliseconds in length. In some embodiments, the delay d may be 60-100 milliseconds in length. In some embodiments, the delay d may be 70-100 milliseconds in length. In some embodiments, the delay d may be 80-100 milliseconds in length. In some embodiments, the delay d may be 90-100 milliseconds in length. In some embodiments, the delay d may be 10-200 milliseconds in length. In some embodiments, the delay d may be 20-200 milliseconds in length. In some embodiments, the delay d may be 30-200 milliseconds in length. In some embodiments, the delay d may be 40-200 milliseconds in length. In some embodiments, the delay d may be 50-200 milliseconds in length. In some embodiments, the delay d may be 60-200 milliseconds in length. In some embodiments, the delay d may be 70-200 milliseconds in length. In some embodiments, the delay d may be 80-200 milliseconds in length. In some embodiments, the delay d may be 90-200 milliseconds in length. In some embodiments, the delay d may be 10-300 milliseconds in length. In some embodiments, the delay d may be 20-300 milliseconds in length. In some embodiments, the delay d may be 30-300 milliseconds in length. In some embodiments, the delay d may be 40-300 milliseconds in length. In some embodiments, the delay d may be 50-300 milliseconds in length. In some embodiments, the delay d may be 60-300 milliseconds in length. In some embodiments, the delay d may be 70-300 milliseconds in length. In some embodiments, the delay d may be 80-300 milliseconds in length. In some embodiments, the delay d may be 90-300 milliseconds in length. In some embodiments, the delay d may be 10-90 milliseconds in length. In some embodiments, the delay d may be 10-80 milliseconds in length. In some embodiments, the delay d may be 10-70 milliseconds in length. In some embodiments, the delay d may be 10-60 milliseconds in length. In some embodiments, the delay d may be 10-50 milliseconds in length. In some embodiments, the delay d may be 10-40 milliseconds in length. In some embodiments, the delay d may be 10-30 milliseconds in length. In some embodiments, the delay d may be 10-20 milliseconds in length.

As described above, in some embodiments a TV streamer may transmit processed audio or sound. In some embodiments, the TV streamer itself may perform this processing. In some embodiments, a TV streamer (e.g., a TV streamer with soundbar functionality in one device) may be configured to adjust the sound profile of sound output over the direct path 120 to provide better sound in the frequencies that are harder to amplify for the hearing aids 110 (e.g., low frequencies, such as below 200 Hz). The device may be configured to “reinforce” that part of the spectrum by boosting low frequencies in sound transmitted over the direct path 120 and thereby help the wearer 112 hear these frequencies better. In particular, the TV streamer may be able to adjust its internal equalizer to make sound fuller. In some embodiments, the TV streamer may be configured to adjust the sound profile by measuring the room impulse response (RIR) and dynamically changing the sound output to avoid reverberant effects in the speech.

In some embodiments, the TV streamer may be configured to adjust the sound profile for either or both of audio output to the hearing aids 110 and sound output over the direct path 120 based on the types of sounds being played by the speaker. For example, the TV streamer may be configured to adjust the sound profile differently for a news broadcast, a live music recording, an action movie, etc. For example, the TV streamer may determine the type of audio being played (e.g., based on metadata associated with the program, or using a neural network trained for audio scene classification) and then retrieve a sound profile adjustment from a database. In some embodiments, the TV streamer may be configured to transmit a command to the hearing aids 110 to turn on a particular mode based on the type of audio being played (e.g., turn on a music mode when music is playing). In some embodiments, the TV streamer may be configured to run noise reduction (which may also be referred to as denoising) algorithms on either or both of audio output to the hearing aids 110 and sound output over the direct path 120. In some embodiments, the TV streamer may be configured to send queues to neural network(s) running in the hearing aids 110 to tune parameters for anti-feedback, noise reduction, beamforming, etc. Generally, the TV streamer may have flexibility to run powerful neural networks, given that the TV streamer may not be significantly constrained by power or processing power. Furthermore, the TV streamer may buffer a certain input amount of audio so that the input to the neural network can provide more temporal context to the neural network. For example, the TV streamer may buffer a window of the audio as much as a tens of milliseconds in length and process that audio through the neural network. In some embodiments, the window may be equal to or greater than 10 milliseconds in length. In some embodiments, the window may be equal to or greater than 20 milliseconds in length. In some embodiments, the window may be equal to or greater than 30 milliseconds in length. In some embodiments, the window may be equal to or greater than 40 milliseconds in length. In some embodiments, the window may be equal to or greater than 50 milliseconds in length. In some embodiments, the window may be equal to or greater than 60 milliseconds in length. In some embodiments, the window may be equal to or greater than 70 milliseconds in length. In some embodiments, the window may be equal to or greater than 80 milliseconds in length. In some embodiments, the window may be equal to or greater than 90 milliseconds in length. In some embodiments, the window may be equal to or greater than 100 milliseconds in length. In some embodiments, the window may be 10-100 milliseconds in length. (As referred to herein, a window that is X-Y milliseconds in length may be equal to X milliseconds in length, equal to Y milliseconds in length, or between X and Y milliseconds in length.) In some embodiments, the window may be 20-100 milliseconds in length. In some embodiments, the window may be 30-100 milliseconds in length. In some embodiments, the window may be 40-100 milliseconds in length. In some embodiments, the window may be 50-100 milliseconds in length. In some embodiments, the window may be 60-100 milliseconds in length. In some embodiments, the window may be 70-100 milliseconds in length. In some embodiments, the window may be 80-100 milliseconds in length. In some embodiments, the window may be 90-100 milliseconds in length. In some embodiments, the window may be 10-200 milliseconds in length. In some embodiments, the window may be 20-200 milliseconds in length. In some embodiments, the window may be 30-200 milliseconds in length. In some embodiments, the window may be 40-200 milliseconds in length. In some embodiments, the window may be 50-200 milliseconds in length. In some embodiments, the window may be 60-200 milliseconds in length. In some embodiments, the window may be 70-200 milliseconds in length. In some embodiments, the window may be 80-200 milliseconds in length. In some embodiments, the window may be 90-200 milliseconds in length. When such a high degree of buffering is introduced, it may increase the latency, so the TV streamer may be further configured to delay the video to account for the audio delay.

When the TV streamer reduces noise in the audio, it may generate a mask that allows the speech in the audio to be extracted from the background noise. The speech can then be mixed with the noise track at an enhanced SNR. The amount of SNR enhancement may be user configurable, either through an app that connects to the TV streamer or on a dial connected to the TV streamer itself. The user may be able to thus turn up or down the volume of the speech or the noise separately, and the enhanced signal may be applied only to audio streamed to the hearing aid or both to the audio in the hearing aid and the audio played back from the soundbar. In some embodiments, the app may also allow the user to adjust the volume of the soundbar and the hearing aid separately. In some embodiments, a neural network may accept both TV audio and video signals as inputs, and output a mask for producing a noise-reduced TV audio signal.

Thus, in some embodiments, neural networks (e.g., trained for reducing noise in audio) may run on a TV stream. In some embodiments, neural networks (e.g., trained for reducing noise in audio) may run on a TV. Further description of such neural networks may be found in U.S. Pat. No. 11,812,225B2, entitled “Method, Apparatus, and System for Neural Network Hearing Aid,” issued Nov. 7, 2023. In some embodiments, the neural networks may be implemented by neural network circuitry (e.g., on a neural network chip) incorporated into the TV streamer or TV. Further description of such neural network circuitry may be found in U.S. Pat. No. 11,886,974, entitled “Neural Network Chip for Ear-Worn Device,” issued Jan. 30, 2024, which is herein incorporated by reference in its entirety.

In some embodiments, a TV streamer with soundbar functionality in one device may be configured to beamform specific audio to the hearing aid wearer(s) (e.g., the wearer 112) so that non-hearing aid wearers may not notice a difference in the sound quality. For example, it may be helpful to boost some specific frequencies for the hearing aid wearer but not for someone sitting in another part of the room not wearing hearing aids. If the TV streamer includes an array of speakers, the TV streamer could use beamforming to send the boosted frequencies only in the hearing aid wearer's direction but send the unboosted sound elsewhere.

It should be appreciated from the above that audio transmitted to hearing aids may be processed differently that audio from which sound transmitted over the direct path is generated.

In some embodiments, the TV streamer may include a visual system such as a camera. The visual system may be configured to validate, based on images/video captured by the visual system, whether a hearing aid is present in the room, as well as determining the location of hearing aids in the room. Validating whether a hearing aid is present in the room may be helpful for determining whether it is necessary to stream audio. Determining the location of hearing aids in the room may be helpful, for example, in performing beamforming as described above and/or determining the proper audio delay as described above. In some embodiments, determining if and where hearing aids are present in a room may include using a face tracking algorithm implemented by the TV streamer's visual system. In some embodiments, the hearing aids could include an infrared light-emitting diode (IR LED) and the TV streamer may include IR sensors configured to localize the IR LEDs.

In some embodiments in which a TV streamer is interposed between the AV source 102 and the TV 104 (e.g., the AV systems 500 and 600), the TV streamer may be configured to delay when it outputs video to the TV 104. For example, if the TV streamer processes audio with a very large neural network that incurs a large latency, the TV streamer may be configured to delay the video in order to synchronize the audio and video. In embodiments in which the TV and the TV streamer are in a single device (e.g., the TV and TV streamer 906 and the TV, TV streamer, and soundbar 1006), the TV streamer may be configured to control its own TV video output delay. Alternatively, audio could be pre-processed with a non-causal neural network and then played back, such that the neural networks need not necessarily be run in real time.

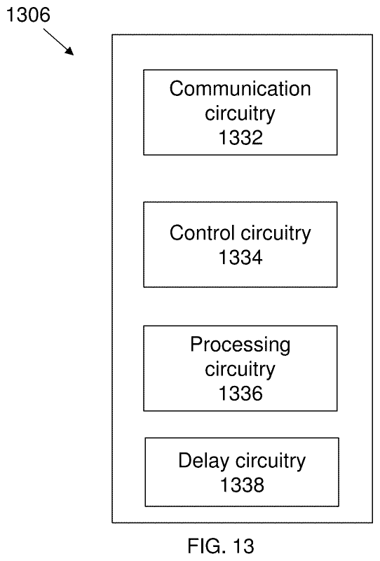

FIG. 13 illustrates a block diagram of a TV streamer 1306, in accordance with certain embodiments described herein. The TV streamer 1306 may be any of the TV streamers without soundbar functionality described herein (e.g., the TV streamers 106, 506, or 706). The TV streamer 1306 includes communication circuitry 1332, control circuitry 1334, processing circuitry 1336, and delay circuitry 1338. The communication circuitry 1332 may be configured to interface with other devices over a wireless connection (e.g., the wireless connection 122, which may be a Bluetooth connection) and/or over a wired connection (e.g., any of the cables described herein). In some embodiments, the communication circuitry 1332 may be configured to receive audio associated with a TV program, as described above. In some embodiments, the communication circuitry may be configured to transmit audio to hearing aids (e.g., the hearing aids 110) over a wireless connection (e.g., the wireless connection 122), as described above. The processing circuitry 1336 may be configured to perform processing. In some embodiments, the processing circuitry 1336 may be configured to reduce noise in audio using a neural network, as described above. In some embodiments, the processing circuitry 1336 may be configured to buffer a window of the audio (e.g., equal to or more than 50 milliseconds in length) prior to using the neural network to reduce noise in the audio, as described above. In some embodiments, the processing circuitry 1336 may be configured to adjust a sound profile of audio based on a type of the audio, as described above. In some embodiments, the processing circuitry may be configured to boost low frequencies in the audio, as described above. The delay circuitry 1338 may be configured to implement any of the delays described herein. For example, the delay circuitry 1338 may include a timer configured to count down until a delay time has elapsed. The control circuitry 1334 may be configured to control operation of the TV streamer 1306. For example, the control circuitry 1334 may be configured to control how the TV streamer 1306 communicates with other devices using the communication circuitry 1332. In some embodiments, the control circuitry 1334 may be configured to control the communication circuitry 1332 to receive audio associated with a TV program; control the communication circuitry 1332 to transmit the audio, or a first processed version of it, to hearing aids (e.g., the hearing aids 110) over a wireless connection (e.g., the wireless connection 122); use the delay circuitry 1338 to determine when a delay time has elapsed; and control the communication circuitry 1332 to transmit the audio, or a second processed version of it, to another device (e.g., the soundbar 108) after the delay time has elapsed, as described above. In some embodiments, the control circuitry 1334 may be configured to control the communication circuitry 1332 to receive video associated with a TV program, and use the delay circuitry 1338 to delay the video prior to controlling the communication circuitry 1332 to transmit the video to a TV, as described above. It should be appreciated that the TV streamer 1306 may include more components than shown.

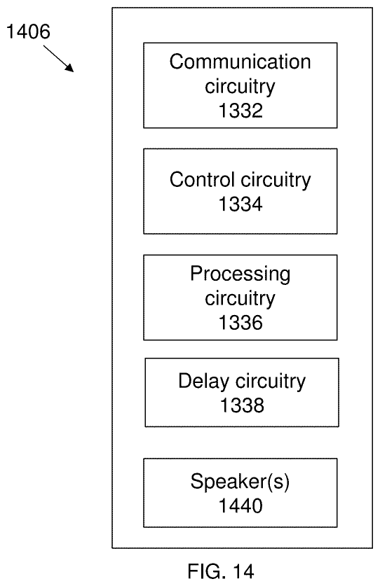

FIG. 14 illustrates a block diagram of a TV streamer 1406, in accordance with certain embodiments described herein. The TV streamer 1406 may be any of the TV streamers with soundbar functionality described herein (e.g., the TV streamers 306, 606, 806, 906, or 1006). The TV streamer 1406 contains the same components as the TV streamer 1406, with the addition of one or more speakers 1440 configured to output sound. In some embodiments, the control circuitry 1334 may be configured to control the communication circuitry 1332 to receive audio associated with a TV program, control the communication circuitry 1332 to transmit the audio, or a first processed version of it, to hearing aids (e.g., the hearing aids 110) over a wireless connection (e.g., the wireless connection 120), use the delay circuitry 1338 to determine when a delay time has elapsed, and control the one or more speakers 1440 to generate sound based on the audio, or a second processed version of it, and output the sound after the delay time has elapsed. It should be appreciated that the TV streamer 1406 may include more components than shown.

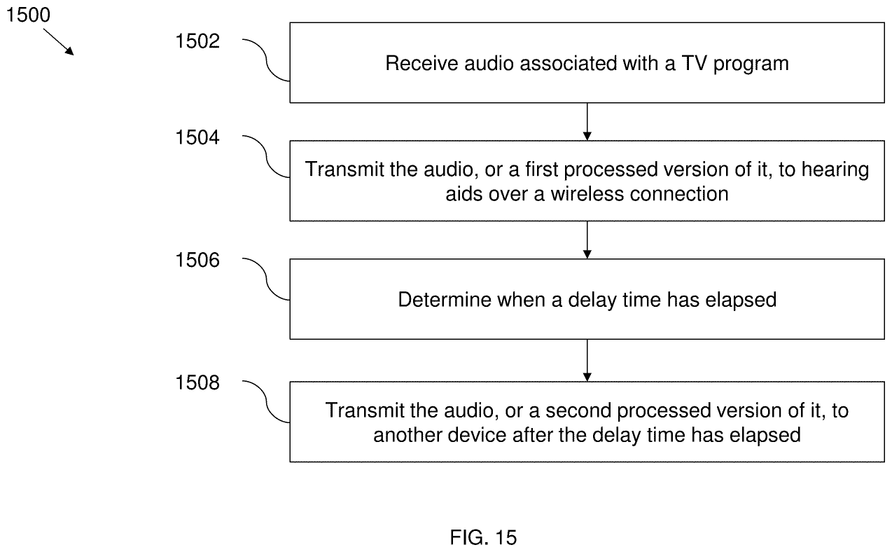

FIG. 15 illustrates a process 1500 for operating an AV system (e.g., any of the AV systems described herein), in accordance with certain embodiments described herein. The process 1500 may be performed by a TV streamer (e.g., any of the TV streamers described herein that do not include soundbar functionality integrated into a single device).

At step 1502, the TV streamer receives audio associated with a TV program.

At step 1504, the TV streamer transmits the audio, or a first processed version of it, to hearing aids over a wireless connection.

At step 1506, the TV streamer determines when a delay time has elapsed.

At step 1508, the TV streamer transmits the audio, or a second processed version of it, to another device (e.g., to a separate soundbar) after the delay time has elapsed. The delay time may be selected such that sound generated by the hearing aids based on the audio (or a processed version of it) transmitted to the hearing aids, and sound generated (e.g., by the soundbar) based on the audio (or a processed version of it) transmitted to the other device, reaches the cars of the hearing aid wearer at the same time or approximately the same time (e.g., within 10 milliseconds of each other). In some embodiments, the first and second processed versions of the audio may be the same. In some embodiments, the first and second processed versions of the audio may be different.

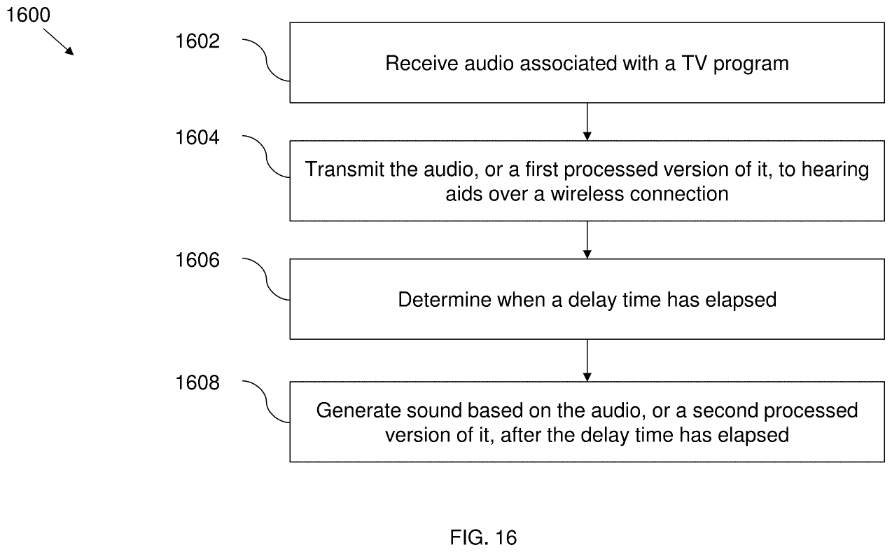

FIG. 16 illustrates a process 1600 for operating an AV system (e.g., any of the AV systems described herein), in accordance with certain embodiments described herein. The process 1600 may be performed by a TV streamer (e.g., any of the TV streamers described herein that include soundbar functionality integrated into a single device).

At step 1602, the TV streamer receives audio associated with a TV program.

At step 1604, the TV streamer transmits the audio, or a first processed version of it, to hearing aids over a wireless connection.

At step 1606, the TV streamer determines when a delay time has elapsed.

At step 1608, the TV streamer generates sound (i.e., in air) based on the audio, or a second processed version of it, after the delay time has elapsed. The delay time may be such that sound generated by the hearing aids based on the audio (or a processed version of it) transmitted to the hearing aids, and the sound transmitted into the air, reaches the cars of the hearing aid wearer at the same time or approximately the same time (e.g., within 10 milliseconds of each other). In some embodiments, the first and second processed versions of the audio may be the same. In some embodiments, the first and second processed versions of the audio may be different.

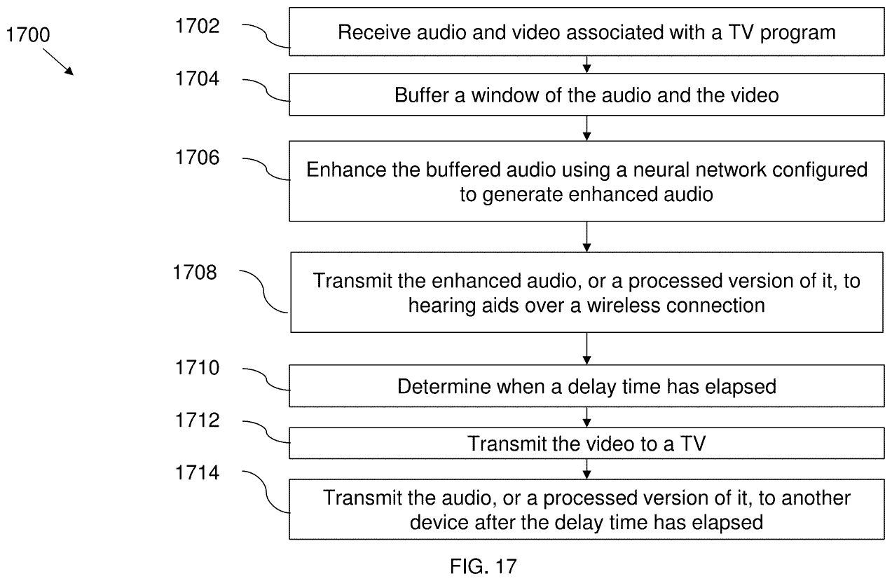

FIG. 17 illustrates a process 1700 for operating an AV system (e.g., any of the AV systems described herein), in accordance with certain embodiments described herein. The process 1700 may be performed by a TV streamer (e.g., any of the TV streamers described herein that do not include soundbar functionality integrated into a single device).

At step 1702, the TV streamer receives audio and video associated with a TV program.

At step 1704, the TV streamer buffers a window of the audio and the video.

At step 1706, the TV streamer enhances the buffered audio using a neural network configured to generate enhanced audio. In some embodiments, the enhanced audio may be increased in volume.

At step 1708, the TV streamer transmits the enhanced audio, or a first processed version of it, to hearing aids over a wireless connection.

At step 1710, the TV streamer determines when a delay time has elapsed.

At step 1712, the TV streamer transmits the video to a TV.

At step 1714, the TV streamer transmits the audio, or a second processed version of it, to another device after the delay time has elapsed. In some embodiments, the transmitted audio may not be enhanced. In some embodiments, the transmitted audio may have lower volume than the audio transmitted to the hearing aids. In some embodiments, the first and second processed versions of the audio may be the same. In some embodiments, the first and second processed versions of the audio may be different.

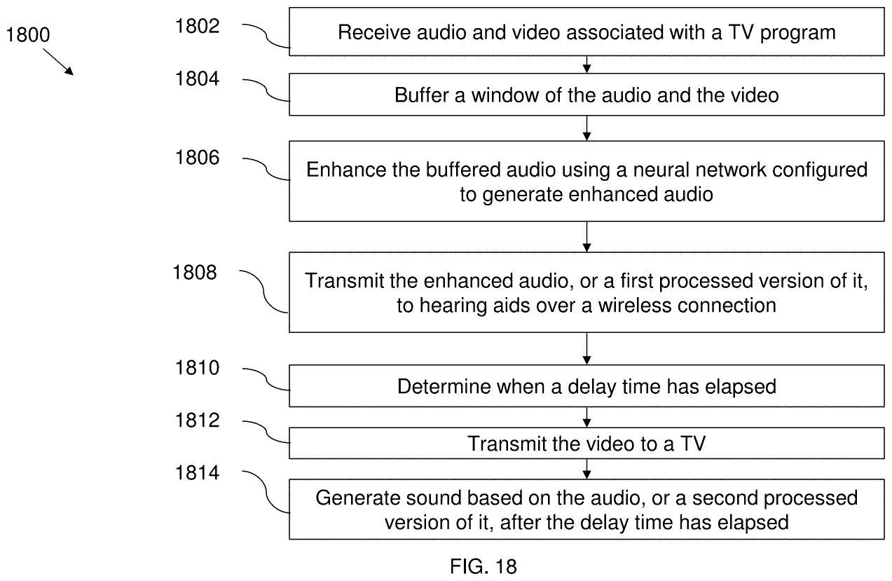

FIG. 18 illustrates a process 1800 for operating an AV system (e.g., any of the AV systems described herein), in accordance with certain embodiments described herein. The process 1800 may be performed by a TV streamer (e.g., any of the TV streamers described herein that include soundbar functionality integrated into a single device). The process 1800 is the same as the process 1700, except that at the last step, the TV streamer generates sound (i.e., in air) based on the audio, or a second processed version of it. In some embodiments, the transmitted audio may not be enhanced. In some embodiments, the transmitted audio may have lower volume than the audio transmitted to the hearing aids.

While the above description has focused on hearing aids, other car-worn devices such as cochlear implants and earphones may use the same apparatuses and methods.

Having described several embodiments of the techniques in detail, various modifications and improvements will readily occur to those skilled in the art. Such modifications and improvements are intended to be within the spirit and scope of the invention. Accordingly, the foregoing description is by way of example only, and is not intended as limiting. For example, any components described above may comprise hardware, software or a combination of hardware and software.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having described above several aspects of at least one embodiment, it is to be appreciated various alterations, modifications, and improvements will readily occur to those skilled in the art. Such alterations, modifications, and improvements are intended to be objects of this disclosure. Accordingly. the foregoing description and drawings are by way of example only.

What is claimed is:

1. A television (TV) streamer comprising:
communication circuitry;
control circuitry; and
delay circuitry; wherein:
the control circuitry is configured to:
control the communication circuitry to receive audio associated with a TV program;
control the communication circuitry to transmit the audio, or a first processed version of it, to hearing aids over a wireless connection;
use the delay circuitry to determine when a delay time has elapsed; and
control the communication circuitry to transmit the audio, or a second processed version of it, to another device after the delay time has elapsed.

2. The TV streamer of claim 1, wherein the delay time is selected such that sound generated based on the audio, or the second processed version of it, transmitted to the other device, and sound generated by the hearing aids based on the audio, or the first processed version of it, reach ears of a wearer of the hearing aids within 10 milliseconds of each other.

3. The TV streamer of claim 1, further comprising processing circuitry configured to reduce noise in the audio using a neural network, and wherein the control circuitry is configured to control the communication circuitry to transmit the noise-reduced audio to the hearing aids.

4. The TV streamer of claim 3, wherein the processing circuitry is further configured to buffer a window of the audio equal to or more than 50 milliseconds in length prior to using the neural network to reduce noise in the audio.

5. The TV streamer of claim 1, wherein the control circuitry is configured to:
control the the communication circuitry to receive video associated with the TV program; and
use the delay circuitry to delay the video prior to controlling the communication circuitry to transmit the video to a TV.

6. The TV streamer of claim 1, wherein the other device comprises a soundbar or a TV.

7. The TV streamer of claim 1, wherein the TV streamer is integrated into a TV.

8. The TV streamer of claim 1, wherein the TV streamer is further configured to measure a streaming delay in streaming data to the hearing aids, and the delay time is based on the streaming delay.

9. The TV streamer of claim 1, further comprising processing circuitry configured to adjust a sound profile of the audio based on a type of the audio.

10. A television (TV) streamer comprising:
communication circuitry;
control circuitry;
delay circuitry; and
one or more speakers; wherein:
the control circuitry is configured to:
control the communication circuitry to receive audio associated with a TV program;
control the communication circuitry to transmit the audio, or a first processed version of it, to hearing aids over a wireless connection;
use the delay circuitry to determine when a delay time has elapsed; and
control the one or more speakers to generate sound based on the audio, or a second processed version of it, after the delay time has elapsed.

11. The TV streamer of claim 10, wherein the delay time is selected such that the sound generated by the one or more speakers based on the audio, or the second processed version of it, and sound generated by the hearing aids based on the audio, or the first processed version of it, reach ears of a wearer of the hearing aids within 10 milliseconds of each other.

12. The TV streamer of claim 10, further comprising processing circuitry configured to reduce noise in the audio using a neural network, and wherein the control circuitry is configured to control the communication circuitry to transmit the noise-reduced audio to the hearing aids.

13. The TV streamer of claim 12, wherein the processing circuitry is further configured to buffer a window of the audio equal to or more than 50 milliseconds in length prior to using the neural network to reduce noise in the audio.

14. The TV streamer of claim 10, wherein:
the communication circuitry is configured to receive video associated with the TV program; and
the control circuitry is configured to delay the video prior to controlling the communication circuitry to transmit the video to a TV.

15. The TV streamer of claim 10, wherein the TV streamer is coupled to a TV or to an audiovisual (AV) source by a single cable.

16. The TV streamer of claim 10, wherein the TV streamer comprises soundbar functionality in a single device.

17. The TV streamer of claim 10, wherein the TV streamer is integrated into a TV.

18. The TV streamer of claim 10, wherein the TV streamer is further configured to measure a streaming delay in streaming data to the hearing aids, and the delay time is based on the streaming delay.

19. The TV streamer of claim 10, further comprising processing circuitry configured to adjust a sound profile of the audio based on a type of the audio.

20. The TV streamer of claim 10, further comprising processing circuitry configured to boost low frequencies in the audio.
